(19) United States
(12) Patent Application Publication
(10) Pub. No.: US 2026/0044960 A1
(43) Pub. Date: Feb. 12, 2026

(54) METHODS FOR DETECTING A MOTION ARTIFACT IN MEDICAL IMAGING DATA

(71) Applicant: Siemens Healthineers AG, Forchheim (DE)

(72) Inventors: Bernhard GEIGER, Cranbury, NJ (US); Jannis DICKMANN, Erlangen (DE)

(73) Assignee: Siemens Healthineers AG, Forchheim (DE)

(21) Appl. No.: 19/295,768

(22) Filed: Aug. 11, 2025

(30) Foreign Application Priority Data
Aug. 12, 2024 (EA) 24194033.7

(51) Int. Cl. G06T 7/00; G06T 7/20; G06T 7/60; G06T 7/70

(52) U.S. Cl. CPC G06T 7/0016; G06T 7/20; G06T 7/60; G06T 7/70; G06T 2200/04; G06T 2207/20216; G06T 2207/20221; G06T 2207/20224; G06T 2207/30168

(57) ABSTRACT

A method for detecting a motion artifact in medical imaging data is provided. The method comprises generating a first image representing at least an overlap region based on a first acquired dataset and generating a second image representing at least the overlap region based on a second acquired dataset; generating a difference map for the overlap region by subtracting the first image and the second image from each other; and detecting the motion artifact by determining a connected region in the difference map, wherein absolute values of the difference map are equal to or greater than a predefined threshold value within the connected region.

### CROSS-REFERENCE TO RELATED APPLICATION(S)

The present application claims priority under 35 U.S.C. § 119 to European Patent Application No. 24194033.7, filed Aug. 12, 2024, the entire contents of which is incorporated herein by reference.

### Field

At least some example embodiments are directed to a computer-implemented method for detecting a motion artifact in medical imaging data, to a corresponding method for medical imaging, to a data processing system for carrying out said computer-implemented method, and to a corresponding computer program product.

### Related Art

Many medical imaging procedures, for example CT (computed tomography) or MRI (magnetic resonance imaging) acquisitions of the chest, are frequently carried out while the patient holds their breath to prevent the organs from moving due to breathing. It is desirable to develop systems that make the breath hold unnecessary for various reasons: sick patients might not be able to hold the breath or might not able to follow the instructions of the medical staff, or the acquisitions are used for radiotherapy treatment planning, where treatment delivery time is too long to hold the breath and thus time-resolved information of the tumor location is required.

A possible solution is to make multiple shorter acquisitions at the same breathing phase and stitch them together later. This can be done for multiple phases of the breathing cycle to acquire time-resolved data. This is leveraged by the fact that the speed of CT systems is so high that at least a block of data can be acquired quasi free of motion artifacts. If the timing is not perfect, however, and/or if the breathing motion is not consistent, the overall may show motion artifacts due to relative motion between subsequent acquisitions. Such motion artifacts may comprise steps and/or replications of structures and might not be usable for the intended purpose. Similar motion artifact may also arise due to other types of motion, such as heartbeat, peristalsis, or external patient motions or movements of the patient support.

### SUMMARY

If such motion artifacts could be detected reliably, they could be documented for further use and/or indicated to a user, for example highlighted in the reconstructed image, et cetera. The user may then for example decide whether the acquisition has to be repeated or whether the motion artifact is not significant or not relevant for the intended purpose.

One or more example embodiments provides a possibility to detect motion artifacts in medical imaging data comprising two acquired datasets acquired at different time periods, whose represented regions overlap, in particular motion artifacts due to relative motions of patients and/or organs between the different time periods.

This is achieved by the subject matter of the independent claim. Further implementations and preferred embodiments are subject matter of the dependent claims.

### BRIEF DESCRIPTION OF THE DRAWINGS

In the following, one or more example embodiments will be explained in detail with reference to specific exemplary implementations and respective schematic drawings. In the drawings, identical or functionally identical elements may be denoted by the same reference signs. The description of identical or functionally identical elements is not necessarily repeated with respect to different figures.

In the figures,

FIG. 1 shows schematically an exemplary implementation of a medical imaging system according to one or more example embodiments;

FIG. 2 shows a schematic flow diagram of an exemplary implementation of a computer-implemented method for detecting a motion artifact in medical imaging data according to one or more example embodiments;

FIG. 3 shows schematically a stitched image with highlighted motion artifacts;

FIG. 4 shows schematically a further stitched image with highlighted motion artifacts;

FIG. 5 shows schematically a further stitched image with highlighted motion artifacts;

FIG. 6 shows schematically a further stitched image with highlighted motion artifacts;

FIG. 7 shows schematically a further stitched image with highlighted motion artifacts; and

FIG. 8 shows schematically a difference map according to a further exemplary implementation of a computer-implemented method for detecting a motion artifact in medical imaging data according to one or more example embodiments.

### DETAILED DESCRIPTION

One or more example embodiments is based on the idea to form a difference map for the overlap region and to determine a connected region in the difference map, wherein absolute values of the difference map are equal to or greater than a predefined threshold value within the connected region.

According to one or more example embodiments, a computer-implemented method for detecting a motion artifact in medical imaging data is provided. Therein, the medical imaging data is received and comprises a first acquired dataset acquired during a first time period and representing a first region of an object and a second acquired dataset acquired during a second time period and representing a second region of the object, wherein the second region of the object overlaps with the first region of the object in an overlap region. A first image representing at least the overlap region is generated depending on the first acquired dataset and a second image representing at least the overlap region is generated depending on the second acquired dataset. A difference map for the overlap region is generated by subtracting the first image and the second image from each other (e.g., subtracting the second image from the first image or subtracting the first image from the second image), in particular by subtracting the respective parts of the first image and the second image representing the overlap region from each other. The motion artifact is detected by determining a connected region in the difference map, such that absolute values of the difference map, in particular respective entries of the difference map, are equal to or greater than a predefined threshold value within the connected region, in particular for all entries within the connected region.

Unless stated otherwise, all steps of the computer-implemented method may be performed by a data processing system, which comprises at least one data processing device. In particular, the at least one data processing device is configured or adapted to perform the steps of the computer-implemented method. For this purpose, the at least one data processing device may for example store a computer program comprising instructions which, when executed by the at least one data processing device, cause the at least one data processing device to execute the computer-implemented method. The expressions “data processing system” and “at least one data processing device” may be used interchangeably, here and in the following. This holds also for respective expressions derived therefrom.

In case the at least one data processing device comprises two or more data processing devices, certain steps carried out by the at least one data processing device may also be understood such that different data processing devices carry out different steps or different parts of a step. In particular, it is not required that each data processing device carries out the steps completely. In other words, carrying out the steps may be distributed amongst the two or more data processing devices.

From each implementation of the computer-implemented method, a respective implementation of a method for detecting a motion artifact, which is not purely computer-implemented, is obtained by including respective steps of generating the medical imaging data by a medical imaging device.

The first time period is different from the second time period. In general, they do not overlap. It is possible that the second time period follows directly after the first time period or vice versa. This is, however, not mandatory. Here and in the following, a motion artifact can be understood as an artifact, which origins from a motion of the object, which is for example a patient, or a part of the object, for example one or more organs of the patient, between the first time period and the second time period. As a consequence, the object or a part of the object has a different position with respect to the medical imaging device during the second time period compared to the first time period. For example, the motion artifact may be visible in a stitched image representing the first region and the second region is generated depending on the first acquired dataset and the second acquired dataset. The motion may for example include a respiratory motion, in particular of the chest and/or diaphragm of the patient, and/or a cardiac motion and/or a peristalsis motion and/or a motion of the patient itself and/or a motion of a patient support like a patient table et cetera. In particular, the motion artifact can occur whether or not there is a motion of the object or the part of the object during the first time period or during the second time period. In case the motion is a cyclic motion such as the respiratory motion or cardiac motion, the first and the second time period may for example nominally correspond to the same phase of the cyclic motion.

That the first image and the second image are subtracted from each other to generate the difference map may for example be understood such that the corresponding part of the first image representing the overlap region is subtracted from the corresponding part of the second image representing the overlap region or vice versa. The entries of the difference map may correspond to the respective differences between the image values of the first and the second image or, for example, to the absolute value of said differences. The difference map may also be considered as a two-dimensional or three-dimensional image. In other words, the first and the second image as well as the difference map may be interpreted as respective pixel values for each of a two-dimensional arrangement of pixels or respective voxel values for each of a three-dimensional arrangement of voxels, respectively.

Depending on the medical imaging device and the acquisition method used for generating the first acquired data set and the second acquired data set, these may represent the first region and the second region, respectively, two-dimensionally or three-dimensionally. For example, in case CT device or an MRI device is used, the first acquired data set and the second acquired data set may correspond to respective three-dimensional reconstructions.

Consequently, also the first image, the second image and the difference map are two-dimensional in case the first acquired data set and the second acquired data set, respectively, are two-dimensional datasets and the first image, the second image and the difference map are three-dimensional in case the first acquired data set and the second acquired data set, respectively, are three-dimensional datasets.

Detecting the motion artifact comprises at determining that the motion artifact is present. Optionally, detecting the motion artifact may comprise localizing the motion artifact, in particular by determining the location of the motion artifact in the difference map, classifying motion artifact according to defined criteria such as size or shape, et cetera.

The connected region may for example be a region of 4-connected pixels or 8-connected pixels in case the difference map is two-dimensional. In other words, two pixels are considered to belong to the same connected region, if they share a common side in case of a 4-connected region or if they share a common side or corner in case of an 8-connected region. Analogously, the connected region may for example be a region of 6-connected voxels or 18-connected voxels or 26-connected voxels in case the difference map is three-dimensional. In other words, two voxels are considered to belong to the same connected region, if they share a common face in case of a 6-connected region or if they share a common face or edge in case of an 18-connected region or if they share a common face or edge or corner in case of a 26-connected region. It is, however, to use different definitions of connectivity.

For determining the connected region, a thresholded difference map may for example be generated by setting all entries of the difference map to zero, whose absolute value is smaller than the threshold value. In this way, the connected region may be determined as a connected region of voxels of the threshold of difference map with non-zero entries.

Once the motion artifact has been detected by the computer-implemented method according to one or more example embodiments, this finding may be used for different applications and purposes. For example, the existence and/or location and/or size and/or geometric shape and/or classification result may be documented, in particular store to a storage device with reference to medical imaging data or the stitched image. The motion artifact may also be highlighted in the stitched image in some cases. Said properties of the detected motion artifact may also be used to evaluate the significance or the criticality of the motion artifact. Depending on the result of the evaluation, the data acquisition may for example be repeated or partly repeated or a specific method intended for the image stitching may be used, which reduces for example the potential impact of the motion artifact.

According to several embodiments, a stitched image representing the first region and the second region is generated depending on the first acquired dataset and the second acquired dataset.

The stitched image may for example be generated by using a known image stitching method combine at least the first image and the second image with each other, in case the first image and the second image do not only represent the overlap region but the whole first region and the whole second region, respectively. It is also possible that a further first image representing the first region is generated based on the first acquired data set and a further first image representing the second region is generated based on the second acquired data set. The stitched image may then for example be generated by using a known image stitching method combine at least the further first image and the further second image with each other.

For example, the stitched image may comprise the first image or further first image for a part of the first region outside of the overlap region and the second image or further second image for a part of the second region outside of the overlap region. For the overlap region, the pixels or voxels of the stitched image may for example be given by averaged values of the respective pixels or voxels of the first image and the second image. The overlap region may, for example, consist of the first part of the overlap region and the second part of the overlap region. This approach may be denoted as blending. As an alternative to the blending, a first part of the overlap region may be given by the first image and a second part of the overlap region may be given by the second image. This approach may be denoted as stacking. It is also possible to combine the blending approach and the stacking approach. In this case, for example the first part of the overlap region may be given by the first image and the second part of the overlap region may for example be given by the averaged values of the respective pixels or voxels of the first image and the second image or vice versa.

The stitched image or a further processed version of the stitched image may for example be displayed on a display device of the data processing system.

According to several embodiments, a location of the motion artifact is determined by determining a location of the connected region based on the difference map and a user output is generated depending on the location of the motion artifact.

The location of the connected region may for example be determined as a predefined representative position within the connected region or as the position and, optionally, orientation of the whole contour of the connected region. The user output may for example indicate the representative position in the corresponding image domain, for example in the stitched image, or the position and, if applicable, orientation of the contour in the corresponding image domain, for example in the stitched image. The user output may, for example, include a visual representation of the location of the motion artifact in the corresponding image domain, for example in the stitched image. Alternatively or in addition the user output may, for example, text output indicating the location of the connected region and/or an acoustic output indicating the existence and/or location of the connected region.

In this way, the user is enabled to directly identify the location of the motion artifact, its relevance or criticality in a simple way.

According to several embodiments, the user output comprises the visual representation of the stitched image, wherein the location of the motion artifact in the stitched image is indicated.

For example, the visual representation may correspond to an augmented version of the stitched image, wherein the representation of the location of the motion artifact is overlaid over the stitched image.

In this way, the user is enabled to directly identify the location of the motion artifact, its relevance or criticality in a simple way.

According to several embodiments, the first image is generated independent of the second acquired dataset and/or the second image is generated independent of the first acquired dataset.

In particular, the first image is generated depending only on the first acquired data set and/or the second image is generated depending only on the second acquired data set.

In particular, in case the first image is generated independent of the second acquired data set and the second image is generated independent of the first acquired data set, this may be particularly beneficial in case the stitched image is generated according to the stacking approach, while this is not mandatory.

According to several embodiments a part of the first image corresponding to the overlap region, in particular the whole respective part of the first image corresponding to the overlap region, is generated depending on the first acquired dataset and the second acquired dataset.

For example, the part of the first image corresponding to the overlap region may be generated depending on averaged data, which is generated by averaging respective parts of the first acquired dataset and the second acquired dataset.

According to several embodiments a part of the second image corresponding to the overlap region, in particular the whole respective part of the second image corresponding to the overlap region, is generated depending on second first acquired dataset and the first acquired dataset.

For example, the part of the second image corresponding to the overlap region may be generated depending on further averaged data, which is generated by averaging respective parts of the first acquired dataset and the second acquired dataset.

According to several embodiments, a first part of the second image corresponding to the first part of the overlap region is generated depending on the first acquired dataset and independent of the second acquired dataset and a second part of the second image corresponding to the second part of the overlap region is generated depending on the second acquired dataset and independent of the first acquired dataset.

According to several embodiments, a first part of the first image corresponding to the first part of the overlap region is generated depending on the first acquired dataset and independent of the second acquired dataset and a second part of the first image corresponding to the second part of the overlap region is generated depending on the second acquired dataset and independent of the first acquired dataset.

The different embodiments for generating the first image and the second image in the overlap region may be combined in different combinations, for example to represent the appearance of the motion artifact in the stitched image as consistent as possible or feasible.

Beneficial but non-limiting examples include:
a) The first image is generated independent of the second acquired dataset and the second image is generated independent of the first acquired dataset
b) The first part of the second image corresponding to a first part of the overlap region is generated depending on the first acquired dataset and independent of the second acquired dataset, the second part of the second image corresponding to a second part of the overlap region is generated depending on the second acquired dataset and independent of the first acquired dataset, and the part of the first image corresponding to the overlap region is generated depending on the averaged data.

According to several embodiments, the motion artifact is classified depending on a size and/or geometric shape of the connected region.

In particular, the classification may comprise assigning a size class of two or more predefined size classes to the motion artifact depending on the area or volume occupied by the connected region in the difference map.

Consequently, the user may assess the relevance or criticality of the motion artifact easier. It is also possible that the user output indicating the existence and/or location et cetera of the motion artifact is only generated or output in case the size of the motion artifact is at least a minimum size according to the classification. Alternatively or in addition, the user output may comprise or indicate the respective size class assigned to the motion artifact.

It is also possible that a plurality of artifacts including the motion artifact and one or more further motion artifacts is detected. The above-mentioned embodiments and the explanations regarding the motion artifact and its detection carry over analogously for the one or more further motion artifacts.

In case the plurality of artifacts is detected, they may for example be filtered or sorted according to their size. In this case, the user output indicating the existence and/or location et cetera of the motion artifact may for example be generated or output at most for the N largest artifacts of the plurality of artifacts, wherein N is a predefined positive integer number, for example N≥1 or N≥2 or N≥3.

In particular, the classification may comprise assigning a shape class of two or more predefined shape classes to the motion artifact depending on the geometric shape of the connected region in the difference map.

The two or more predefined shape classes may for example correspond to different causes of the motion artifact, such as respiratory motion of the chest, respiratory motion of the diaphragm, peristaltic motion, cardiac motion, patient motion, et cetera.

Consequently, the user may assess the relevance or criticality of the motion artifact easier. It is also possible that the user output comprises or indicates the respective shape class assigned to the motion artifact.

In particular, the classification may comprise assigning a size-and-shape class of two or more predefined size-and-shape classes to the motion artifact depending on the size and the geometric shape of the connected region in the difference map.

Consequently, the user may assess the relevance or criticality of the motion artifact easier. In particular, the shape of the motion artifact may influence how the size of the motion artifact affects the criticality of the motion artifact or vice versa.

According to several embodiments, the first acquired dataset and the second acquired dataset correspond to CT datasets or MRI datasets.

According to several embodiments, the first image and the second image are three-dimensional volume reconstructions, the difference map is a three-dimensional map, and the connected region is a three-dimensional region in the difference map. In particular, also the first region of the object and the second region of the object are three-dimensional regions.

In such embodiments, the first region and the second region of the object may for example differ by a shift in one spatial direction, denoted for example as z-direction. Depending on the used medical imaging device, the z-direction may for example correspond to a direction perpendicular to a plane in which the detector and X-ray source of the CT device rotate or the direction of the main magnetic field of the MRI device.

According to one or more example embodiments, a method for medical imaging is provided. Therein, a first acquired dataset representing a first region of an object is acquired during a first time period by a medical imaging device and a second acquired dataset representing a second region of the object is acquired during a second time period by the medical imaging device. The second region of the object overlaps with the first region of the object in an overlap region. A computer-implemented method for detecting a motion artifact according to one or more example embodiments is carried out based on the first acquired dataset and the second acquired dataset. A stitched image representing the first region and the second region is generated depending on the first acquired dataset and the second acquired dataset.

For example, a user output is generated based on the detection of the motion artifact.

According to several embodiments of the method for medical imaging, the first acquired dataset and the second acquired dataset are acquired by a CT device or by an MRI device and/or the first image and the second image are generated as three-dimensional volume reconstructions, the difference map is generated as a three-dimensional map, and the connected region is a three-dimensional region in the difference map.

According to several embodiments, the first time period corresponds, in particular nominally corresponds, to a predefined phase of a cyclic motion, for example a predefined cardiac phase or predefined respiratory phase, of the object. The first acquired dataset is acquired at a fixed first position of the object according to a predefined direction. The second time period corresponds, in particular nominally corresponds, to the same predefined phase of the cyclic, for example the cardiac phase or respiratory phase. The second acquired dataset is acquired at a fixed second position of the object according to the predefined direction, which differs from the first position.

That the first and the second time period nominally correspond to the phase of the cyclic motion may be understood such that they should theoretically correspond to the same phase of the cyclic motion, but there may be deviations due to physiological reasons, inaccurate timing of the first and the second time period with respect to each other, different behavior, for example breathing behavior, of the patient, et cetera.

That the first acquired dataset is acquired at the fixed first position and the second acquired dataset is acquired at the fixed second position may for example be understood such that the position of the object along the predefined direction, in particular the z-direction, is constant during the first time period. During the second time period it is also constant but different from the position during the first time period, such that the overlap region results as described above.

Such embodiments are particularly beneficial for imaging a relatively large part of the object nominally the same phase of the cyclic motion. The method steps may, in particular, be repeated for different phases of the cyclic motion.

According to several embodiments, the first time period corresponds to a predefined phase of a cyclic motion, for example a predefined cardiac phase or a predefined respiratory phase. The second time period corresponds to the predefined phase of the cyclic motion. The object is moved along a predefined direction during the first time period and during the second time period and during a further time period between the first time period and the second time period.

The motion is, for example, carried out with a constant speed and/or constantly along the same direction. Consequently, in particular for CT, a spiral data acquisition is implemented. In this case, one or more example embodiments is particularly beneficial, since the constant motion bears an increased risk for not optimal timing of the first time period and the second time period.

Further implementations of the method follow directly from the various embodiments of the computer-implemented method and vice versa. In particular, individual features and corresponding explanations as well as advantages relating to the various implementations of the computer-implemented method according to one or more example embodiments can be transferred analogously to corresponding implementations of the method according to one or more example embodiments.

According to one or more example embodiments, a data processing system, which is configured to carry out a computer-implemented method according to one or more example embodiments, is provided.

In the present disclosure, the expressions “data processing system” and “at least one data processing device” may be used interchangeably. A data processing device may in particular be understood as a data processing device, which comprises processing circuitry. The data processing device can therefore in particular process data to perform computing operations. This may also include operations to perform indexed accesses to a data structure, for example a look-up table, LUT, as well as a data processing process implemented in hardware.

In particular, the data processing device may include one or more computers, one or more microcontrollers, and/or one or more integrated circuits, for example, one or more application-specific integrated circuits, ASIC, one or more field-programmable gate arrays, FPGA, and/or one or more systems on a chip, SoC. The data processing device may also include one or more processors, for example one or more microprocessors, one or more central processing units, CPU, one or more graphics processing units, GPU, and/or one or more signal processors, in particular one or more digital signal processors, DSP. The data processing device may also include a physical or a virtual cluster of computers or other of said units.

In various embodiments, the data processing device includes one or more hardware and/or software interfaces and/or one or more memory units.

A memory unit may be implemented as a volatile data memory, for example a dynamic random access memory, DRAM, or a static random access memory, SRAM, or as a non-volatile data memory, for example a read-only memory, ROM, a programmable read-only memory, PROM, an erasable programmable read-only memory, EPROM, an electrically erasable programmable read-only memory, EEPROM, a flash memory or flash EEPROM, a ferroelectric random access memory, FRAM, a magnetoresistive random access memory, MRAM, or a phase-change random access memory, PCRAM.

According to one or more example embodiments, comprising a medical imaging device, for example a CT device or an MRI device, and a data processing system according to one or more example embodiments is provided.

In particular, the medical imaging device is configured to generate the first acquired data set and the second acquired data set.

According to one or more example embodiments, a computer program comprising instructions is provided. When the instructions are executed by a data processing system, the instructions cause the data processing system to carry out a computer-implemented method according to one or more example embodiments.

The instructions may be provided as program code, for example. The program code can for example be provided as binary code or assembler and/or as source code of a programming language, for example C, and/or as program script, for example Python.

According to one or more example embodiments, a further computer program comprising further instructions is provided. When the further instructions are executed by a according to one or more example embodiments, in particular by the data processing system of the medical imaging system, the further instructions cause the medical imaging system to carry out a method for medical imaging according to one or more example embodiments.

The further instructions may be provided as program code, for example. The program code can for example be provided as binary code or assembler and/or as source code of a programming language, for example C, and/or as program script, for example Python.

According to one or more example embodiments, a computer-readable storage medium, in particular a tangible and/or non-transient computer readable storage medium, storing a computer program and/or a further computer program according to one or more example embodiments is provided.

The computer program, the further computer program and the computer-readable storage medium are respective computer program products comprising the instructions and/or the further instructions.

Further features and feature combinations of one or more example embodiments are obtained from the figures and their description as well as the claims. In particular, further implementations of one or more example embodiments may not necessarily contain all features of one of the claims. Further implementations of one or more example embodiments may comprise features or combinations of features, which are not recited in the claims.

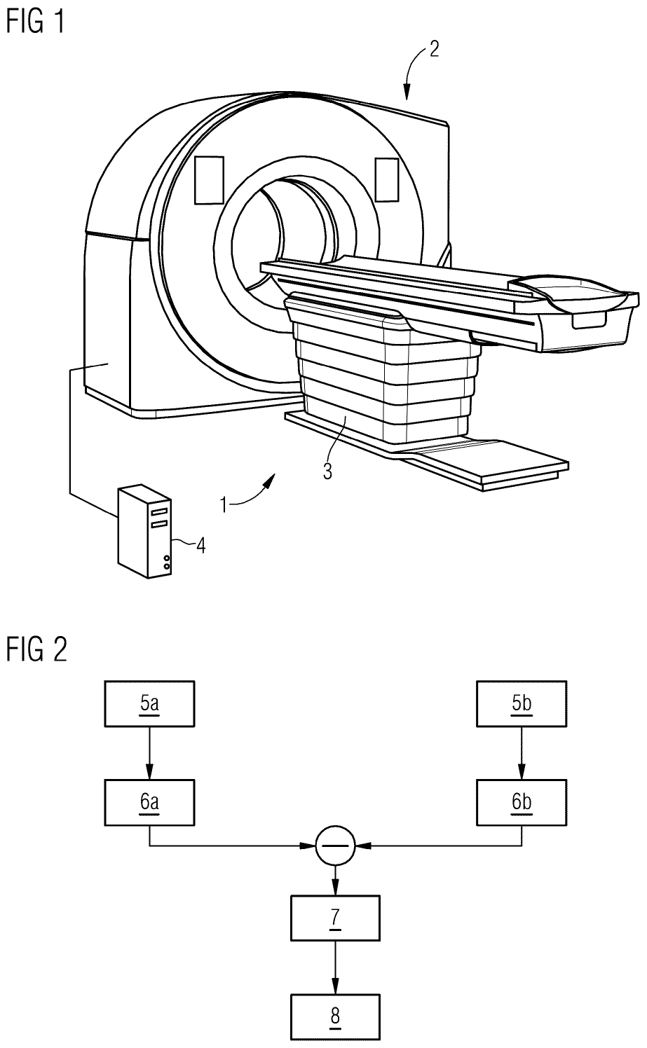

FIG. 1 shows schematically an exemplary implementation of a medical imaging system 1 according to one or more example embodiments. The medical imaging system 1 comprises a medical imaging device 2, which is displayed as a CT device in FIG. 1. The medical imaging system one may also comprise a support 3, for example a patient table, on which an object 10, 11, 13, 14a, 14b, 14c, 15, 16, in particular a patient, to be imaged by the medical imaging device 2 may be placed.

The medical imaging device 2 is configured to acquire a first acquired dataset 5a representing a first region of an object 10, 11, 13, 14a, 14b, 14c, 15, 16 during a first time period and a second acquired dataset 5b representing a second region of the object 10, 11, 13, 14a, 14b, 14c, 15, 16 during a second time period by the medical imaging device, wherein the second region of the object 10, 11, 13, 14a, 14b, 14c, 15, 16 overlaps with the first region of the object 10, 11, 13, 14a, 14b, 14c, 15, 16 in an overlap region.

In some implementations, the first and the second time period correspond to the same phase of a cyclic motion, for example a respiratory or cardiac motion of the patient. For example, the object may be shifted along a predefined direction, in particular the z-direction perpendicular to the rotational plane of the CT device, between the first time period and the second time period. Consequently, the first region and the second region of the object 10, 11, 13, 14a, 14b, 14c, 15, 16 Represent different regions shifted along said direction, which overlap in the overlap region.

The medical imaging device 1 further comprises a data processing system 4 according to one or more example embodiments, which is configured to carry out a computer-implemented method for detecting a motion artifact 12a, 12b, 12c, 12d, 12e, 12f, 12g, 12h, 12i, 12j, 12k in the medical imaging data according to one or more example embodiments.

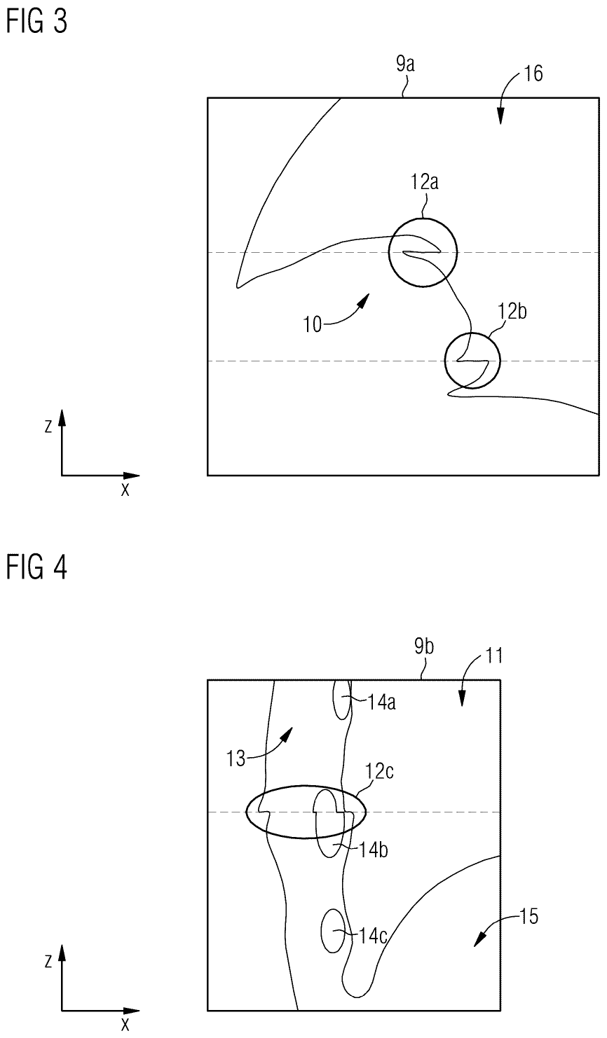

The data processing system 4 may for example generate a stitched image 9a, 9b, 9c, 9d, 9e (see FIG. 3 to FIG. 7) representing the first region and the second region depending on the first acquired dataset 5a and the second acquired dataset 5b. The stitched image 9a, 9b, 9c, 9d, 9e may then for example be displayed on a display device of the medical imaging system 1, for example of the data processing system 4. In particular, a marker indicating a location of the motion artifact 12a, 12b, 12c, 12d, 12e, 12f, 12g, 12h, 12i, 12j, 12k may be overlaid over the stitched image 9a, 9b, 9c, 9d, 9e.

FIG. 2 shows a schematic flow diagram of an exemplary implementation of a computer-implemented method for detecting a motion artifact 12a, 12b, 12c, 12d, 12e, 12f, 12g, 12h, 12i, 12j, 12k.

Therein, a first image 6a representing at least the overlap region is generated depending on the first acquired dataset 5a and a second image 6b representing at least the overlap region is generated depending on the second acquired dataset 5b. A difference map 7 (see FIG. 8) for the overlap region is generated by subtracting the first image 6a and the second image 6b from each other. The motion artifact 12a, 12b, 12c, 12d, 12e, 12f, 12g, 12h, 12i, 12j, 12k is detected by determining a connected region 8 in the difference map 7, wherein absolute values of the difference map 7 are equal to or greater than a predefined threshold value within the connected region 8.

FIG. 3 to FIG. 7 show various schematic representations of organ contours in the chest 16 and lower abdomen 11, respectively, mimicking examples for stitched images 9a, 9b, 9c, 9d, 9e. Horizontal dashed lines correspond to stitching positions in z-direction according to a stacking approach.

FIG. 3 depicts a contour of the heart 10. There are three segments shown, whose underlying raw data has been acquired during different time periods. Apparently, in the upper and lower segments, the heart has been less contracted than in the middle segment. This leads to corresponding motion artifacts 12a, 12b at the boundaries between the segments.

FIG. 4 depicts a contour of the rib cage 14a, 14b, 14c and the chest wall 13 as well as the diaphragm 15. There are two segments shown, whose underlying raw data has been acquired during different time periods. Apparently, in the upper segment, the chest wall has been located more to the left than in the lower segment. This leads to a corresponding motion artifact 12c, which indicates a motion due to chest breathing at the boundary between the segments.

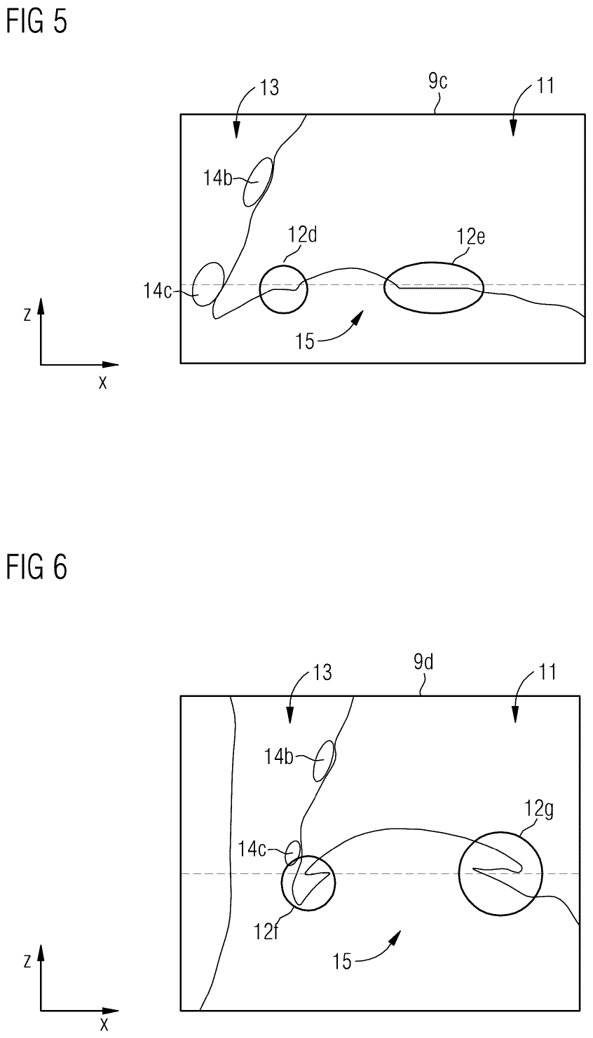

FIG. 5 depicts a contour of the rib cage 14b, 14c and the chest wall 13 as well as the diaphragm 15. There are two segments shown, whose underlying raw data has been acquired during different time periods. Apparently, in the upper segment, the diaphragm 15 has been contracted stronger than in the lower segment. This leads to corresponding motion artifacts 12d, 12e, which indicates a motion due to diaphragmatic breathing at the boundary between the segments.

FIG. 6 depicts a contour of the rib cage 14b, 14c and the chest wall 13 as well as the diaphragm 15. There are two segments shown, whose underlying raw data has been acquired during different time periods. Apparently, in the upper segment, the diaphragm 15 has been contracted less than in the lower segment. This leads to corresponding motion artifacts 12f, 12g, which indicates a motion due to diaphragmatic breathing at the boundary between the segments.

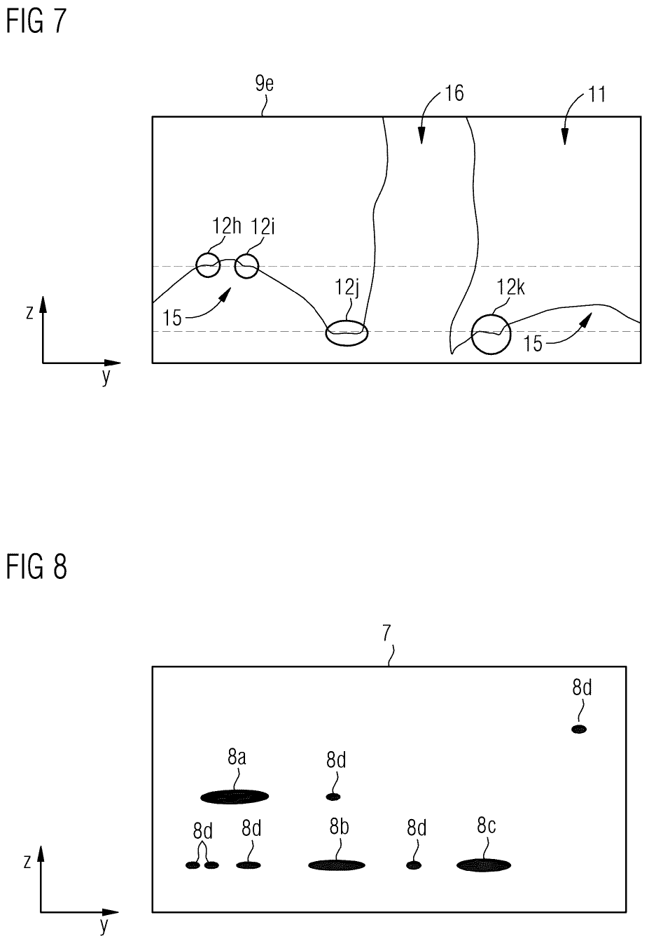

FIG. 7 depicts a contour of the spine 16 and the diaphragm 15. There are three segments shown, whose underlying raw data has been acquired during different time periods. Apparently, in the middle segment, the diaphragm 15 has been contracted stronger than in the lower segment. In the upper segment, the diaphragm 15 has been contracted stronger than in the middle segment. This leads to corresponding motion artifacts 12h, 12i, 12j, 12k, which indicates a motion due to diaphragmatic breathing at the boundary between the segments.

It is noted that FIG. 3 to FIG. 7 show two-dimensional stitched images 9a, 9b, 9c, 9d, 9e or two-dimensional sections of three-dimensional stitched images 9a, 9b, 9c, 9d, 9e.

FIG. 8 shows schematically a thresholded difference map 7 for the example of FIG. 7. Therein, all voxels or pixels, respectively, in the difference map 7, whose entries have an absolute value of at least a predefined threshold value, are shown as filled regions, while all other voxels or pixels, respectively, are empty. One can easily identify several connected regions 8a, 8b, 8c, 8d of filled voxels or pixels, respectively, which correspond to motion artifacts in the stitched image 9e. For example, the connected region 8a may correspond to the motion artifacts 12h, 12i, the connected region 8b may correspond to the motion artifact 12j, and the connected region 8c may correspond to the motion artifact 12k. The remaining connected regions 8d, which are significantly smaller than the connected regions 8a, 8b, 8c may correspond to minor motion artifacts, which are not depicted in the stitched image 9e.

As described, one or more example embodiments provides a simple and reliable way to detect motion artifacts in medical imaging data.

In several embodiments, the motion artifacts correspond to inaccurate alignments of multiple acquisitions, which lead to incorrect three-dimensional data in a given phase of a cyclic motion.

In several embodiments, the approach according to the invention allows to parametrize and determine the severity of the misalignments in a fast and accurate manner. In particular, the subtraction operation and the connected component analysis are simple to implement and fast to carry out.

In particular, artifacts due to various kinds of motion, for example breathing, heartbeat, peristalsis or external patient motions or movements of the patient support, may be detected.

In several embodiments, the medical imaging data or the stitched images may be discarded or approaches to re-align the different portions of data may be applied, for example deformable registration techniques.

In several embodiments, the individual acquisitions are done with a small overlap. Each acquisition may cover a range up to the full detector width. The overlap may for example be approximately 10% of the detector width.

In several embodiments, two three-dimensional images, in particular volumes, are reconstructed from the acquired data. In one volume, voxels in the overlap region are reconstructed only from the acquisition with the lower z-coordinate, and in the other volume only data from the acquisition with the dataset according to the higher z-coordinate are used. Alternatively, one volume may be reconstructed by merging, in particular averaging, data in the overlap region and the other volume may be reconstructed without merging and a hard transition at the center of the overlap region. In some embodiments, the two volumes may be composed of only the overlap region.

In several embodiments, the two volumes are subtracted, resulting in non-zero differences only in the vicinity of the overlap regions.

In several embodiments, the subtracted values are thresholded such that |s|>T, wherein s is the difference value, and T is the threshold value. The parameter T may be used to parametrize the size of the motion artifacts.

In several embodiments, the thresholded foreground is divided into connected components. In several embodiments, connected components below a predefined size S are discarded. In several embodiments, center points of the largest connected components are used to indicate corresponding misalignments. The parameter S may be used to parametrize the size of the motion artifacts.

In several embodiments, a mask of specific organs can be used to limit the motion artifact detection to specific body regions.

In several embodiments, the shape of the connected components may be used to select specific motion directions, for example if one is interested primarily in anterior-posterior motion, one could examine the largest anterior-posterior diameter in the connected components. For example, the specific shape of the connected region allows to identify the direction of the underlying motion and therefore to distinguish different types of motion. For example, a diaphragmatic motion may be distinguished from a motion of the chest wall in this way.

In several embodiments, morphological operations, for example erosion, may be used to further parametrize the motion artifacts. This may help to distinguish different types of underlying motions from each other, for example by differentiating between relatively long and/or flat connected regions on the one hand and relatively short and/or broad connected regions. For example, if the connected region survives the erosion process, which needs to be parametrized in a suitable manner, the underlying motion may be due to diaphragmatic breathing, while otherwise it may be due to chest breathing, for example.

Independent of the grammatical term usage, individuals with male, female or other gender identities are included within the term.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuity such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility (also referred to as a data processing facility) or computer device to execute the program of any of the above mentioned embodiments and/or to perform the method of any of the above mentioned embodiments.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the invention has been illustrated and described in detail by the preferred exemplary embodiments, it is not limited by the disclosed examples and a person skilled in the art can derive other variation here from without departing from the protective scope of the invention.

1. A computer-implemented method for detecting a motion artifact in medical imaging data, wherein the medical imaging data includes a first acquired dataset acquired during a first time period and representing a first region of an object and a second acquired dataset acquired during a second time period and representing a second region of the object, wherein the second region of the object overlaps with the first region of the object in an overlap region, the method comprising:
generating a first image representing at least the overlap region based on the first acquired dataset and generating a second image representing at least the overlap region based on the second acquired dataset;
generating a difference map for the overlap region by subtracting the first image and the second image from each other; and
detecting the motion artifact by determining a connected region in the difference map, wherein absolute values of the difference map are equal to or greater than a predefined threshold value within the connected region.

2. The computer-implemented method of claim 1, further comprising:
determining a location of the motion artifact by determining a location of the connected region based on the difference map; and
generating a user output based on the location of the motion artifact.

3. The computer-implemented method of claim 2, further comprising:
generating a stitched image representing the first region and the second region based on the first acquired dataset and the second acquired dataset, wherein
the user output comprises a visual representation of the stitched image, wherein the location of the motion artifact in the stitched image is indicated.

4. The computer-implemented method of claim 1, wherein the generating the first image generates the first image independent of the second acquired dataset.

5. The computer-implemented method of claim 1, further comprising:
generating a part of the first image corresponding to the overlap region based on the first acquired dataset and the second acquired dataset.

6. The computer-implemented method of claim 5, wherein the generating the part of the first image includes:
generating averaged data representing the overlap region by averaging respective parts of the first acquired dataset and the second acquired dataset, and
generating the part of the first image corresponding to the overlap region based on the averaged data.

7. The computer-implemented method of claim 1, further comprising:
generating a first part of the second image corresponding to a first part of the overlap region based on the first acquired dataset and independent of the second acquired dataset; and
generating a second part of the second image corresponding to a second part of the overlap region based on the second acquired dataset and independent of the first acquired dataset.

8. The computer-implemented method of claim 1, wherein the motion artifact is classified based on at least one of a size or a geometric shape of the connected region.

9. The computer-implemented method of claim 8, wherein a direction of a motion, which has caused the motion artifact, is determined depending on the geometric shape of the connected region.

10. The computer-implemented method of claim 1, wherein at least one of
the first acquired dataset and the second acquired dataset correspond to computed tomography datasets or magnetic resonance imaging datasets, or
the first image and the second image are three-dimensional volume reconstructions, the difference map is a three-dimensional map, and the connected region is a three-dimensional region in the difference map.

11. A method for medical imaging, comprising:
acquiring a first dataset representing a first region of an object during a first time period by a medical imaging device and acquiring a second dataset representing a second region of the object during a second time period by the medical imaging device, wherein the second region of the object overlaps with the first region of the object in an overlap region; and
performing the method of claim 1; and
generating a stitched image representing the first region and the second region based on the first acquired dataset and the second acquired dataset.

12. The method of claim 11, wherein
the first time period corresponds to a predefined cardiac phase or respiratory phase,
the first acquired dataset is acquired at a fixed first position of the object according to a predefined direction,
the second time period corresponds to the predefined cardiac phase or respiratory phase, and
the second acquired dataset is acquired at a fixed second position of the object according to the predefined direction, the fixed second position differs from the first position.

13. The method of claim 11, wherein
the first time period corresponds to a predefined cardiac phase or respiratory phase,
the second time period corresponds to the predefined cardiac phase or respiratory phase,
the object is moved along a predefined direction during the first time period and the second time period and during a further time period between the first time period and the second time period.

14. A data processing system configured to perform the method of claim 1.

15. A non-transitory computer readable medium comprising instructions, when executed by a data processing system, cause the data processing system to perform the method of claim 1.

16. The computer-implemented method of claim 3, wherein the generating the first image generates the first image independent of the second acquired dataset.

17. The computer-implemented method of claim 6, further comprising:
generating a first part of the second image corresponding to a first part of the overlap region based on the first acquired dataset and independent of the second acquired dataset; and
generating a second part of the second image corresponding to a second part of the overlap region based on the second acquired dataset and independent of the first acquired dataset.

18. The computer-implemented method of claim 17, wherein the motion artifact is classified based on at least one of a size or a geometric shape of the connected region.

19. The computer-implemented method of claim 18, wherein a direction of a motion, which has caused the motion artifact, is determined depending on the geometric shape of the connected region.

20. The computer-implemented method of claim 19, wherein at least one of
the first acquired dataset and the second acquired dataset correspond to computed tomography datasets or magnetic resonance imaging datasets, or
the first image and the second image are three-dimensional volume reconstructions, the difference map is a three-dimensional map, and the connected region is a three-dimensional region in the difference map.
